(19) United States
(12) Patent Application Publication
(10) Pub. No.: US 2018/0284864 A1
(43) Pub. Date: Oct. 4, 2018

(54) DYNAMIC CLOCK AND VOLTAGE SCALING OF CPU SUBSYSTEM BASED ON WI-FI COMMUNICATIONS

(71) Applicant: QUALCOMM Incorporated, San Diego, CA (US)

(72) Inventors: Sandip HomChaudhuri, San Jose, CA (US); Amitabh Menon, Cupertino, CA (US); Srikant Kuppa, Fremont, CA (US); Pradeep Kumar Yenganti, Cupertino, CA (US); Subramania Sharma Thandaveswaran, Milpitas, CA (US); Harpreet Singh Saluja, Hyderabad (IN); Pankaj Deshpande, San Diego, CA (US)

(21) Appl. No.: 15/474,949

(22) Filed: Mar. 30, 2017

(51) Int. Cl. G06F 1/32; G06F 13/42; G06F 13/40

(52) U.S. Cl. CPC G06F 1/324; G06F 1/3296; H04W 84/12; G06F 13/4022; G06F 13/4282

(57) ABSTRACT

A method for dynamic clock and voltage scaling (DCVS) in a central processing unit (CPU) subsystem of a wireless communication device. The method may be implemented by a DCVS controller of the wireless communication device. The DCVS controller monitors data packets communicated by the CPU subsystem over a wireless local area network (WLAN) and determines one or more metrics of the data packets communicated by the CPU subsystem. The DCVS controller then dynamically configures an operating frequency of one or more hardware resources of the CPU subsystem based at least in part on the one or more metrics. The one or more metrics may include, for example, a packet rate, payload size, aggregation factor, packet size, or number of descriptors associated with the data packets.

### TECHNICAL FIELD

The present embodiments relate generally to wireless networks, and specifically to dynamic clock and voltage scaling (DCVS) techniques based on Wi-Fi communications.

### BACKGROUND OF RELATED ART

A wireless local area network (WLAN) may be formed by one or more access points (APs) that provide a shared wireless medium for use by a number of client devices or stations (STAs). WLANs that operate in accordance with the IEEE 802.11 family of standards are commonly referred to as Wi-Fi networks. Each AP, which may correspond to a Basic Service Set (BSS), periodically broadcasts beacon frames to enable any STAs within wireless range of the AP to establish and/or maintain a communication link with the WLAN. In a typical WLAN, only one STA may use the wireless medium at any given time, and each STA may be associated with only one AP at a time. As a result, some STAs may experience substantial amounts of “idle” time (e.g., the STAs do not transmit or receive data) while connected to a WLAN.

To save power, many STAs are configured to enter into a “sleep” state when they are not transmitting or receiving data. While in the sleep state, the STA may temporarily power down its transceivers and/or other hardware resources to reduce power consumption. Each STA periodically returns to an active state to receive beacons from the AP and/or communicate with other devices in the WLAN. While in the active state, the STA's transceivers and/or other hardware resources are typically configured for maximum performance (e.g., operating at their highest supported clock speeds and/or bandwidths) to support worst-case traffic requirements. However, because traffic conditions often vary, operating the STA's hardware resources at maximum performance may not always be optimal from a power savings standpoint.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A method for dynamic clock and voltage scaling (DCVS) in a central processing unit (CPU) subsystem of a wireless communication device is disclosed. The method may be implemented by a DCVS controller of the wireless communication device. The DCVS controller monitors data packets communicated by the CPU subsystem over a wireless local area network (WLAN) and determines one or more metrics of the data packets communicated by the CPU subsystem. The DCVS controller then dynamically configures an operating frequency of one or more hardware resources of the CPU subsystem based at least in part on the one or more metrics. The one or more metrics may include, for example, a packet rate, payload size, aggregation factor, packet size, or number of descriptors associated with the data packets.

In some aspects, the one or more metrics may indicate a burst of outgoing data traffic. Accordingly, the DCVS controller may increase the operating frequency of the one or more hardware resources for a threshold duration at the start of the burst. The DCVS controller may then reduce the operating frequency of the one or more hardware resources, for the remainder of the burst, after the threshold duration has elapsed.

In some other aspects, the one or more metrics may indicate a duration of inactivity for outgoing data traffic. Accordingly, the DCVS controller may generate an outgoing data packet if the duration of inactivity exceeds an inactive threshold. The DCVS controller may then decrease the operating frequency of the one or more hardware resources if the duration of inactivity exceeds an inactive threshold.

The DCVS controller may reduce the operating frequency of at least one of the hardware resources provided along a first signal path, between a wireless interface and a memory, if at least one of the payload size or the packet rate drops below a corresponding threshold level. The hardware resources provided along the first signal path may include, for example, the wireless interface, a bus coupled between the wireless interface and the memory, and a memory controller that interfaces the wireless interface with the memory.

The DCVS controller may reduce the operating frequency of at least one of the hardware resources provided along a second signal path, between a wireless interface and a processor, if the packet rate drops below a threshold level or the aggregation factor increases beyond a threshold amount. The hardware resources provided along the second signal path may include, for example, the wireless interface, the processor, a memory controller, a first bus coupled between the memory controller and the processor, and a second bus coupled between the memory controller and the wireless interface.

The DCVS controller may reduce the operating frequency of at least one of the hardware resources provided along a third signal path, between a processor and a memory, if the packet rate drops below a threshold level or the aggregation factor increases beyond a threshold amount. The hardware resources provided along the third signal path may include, for example, the processor, a bus coupled between the processor and the memory, and a memory controller that interfaces the processor with the memory.

Still further, in some aspects, the DCVS controller may selectively increase the operating frequency of the one or more hardware resources at a first rate. The DCVS controller may then selectively decrease the operating frequency of the one or more hardware resources at a second rate. Specifically, the first rate may be greater than the second rate.

### BRIEF DESCRIPTION OF THE DRAWINGS

The present embodiments are illustrated by way of example and are not intended to be limited by the figures of the accompanying drawings.

FIG. 1 shows an example wireless network system within which the example embodiments may be implemented.

FIG. 2 is a block diagram of a wireless communication device in accordance with example embodiments.

FIG. 3 is a block diagram of a central processing unit (CPU) subsystem of a wireless communication device, in accordance with example embodiments.

FIG. 4 is a block diagram of a packet-based dynamic clock and voltage scaling (DCVS) controller, in accordance with example embodiments.

FIG. 5 is a block diagram of a DCVS control system for a wireless communication device, in accordance with example embodiments.

FIG. 6 is an illustrative flowchart depicting a packet-based DCVS operation in accordance with example embodiments.

FIG. 7 is an illustrative flowchart depicting a more detailed DCVS operation based on incoming and/or outgoing data packets, in accordance with example embodiments.

FIG. 8 is an illustrative flowchart depicting a packet-based DCVS operation with asynchronous triggers, in accordance with example embodiments.

### DETAILED DESCRIPTION

The example embodiments are described below in the context of wireless local area networks (WLANs) for simplicity only. It is to be understood that the example embodiments are equally applicable to other wireless networks (e.g., cellular networks, pico networks, femto networks, satellite networks, etc.), as well as for systems using signals of one or more wired standards or protocols (e.g., Ethernet and/or HomePlug/PLC standards). As used herein, the terms “wireless local area network,” “WLAN,” and “Wi-Fi” may include communications governed by the IEEE 802.11 family of standards, BLUETOOTH® (“Bluetooth”), communications governed by the 802.15.4 family of standards (e.g., ZigBee, Thread, Z-Wave, etc.), HiperLAN (a set of wireless standards, comparable to the IEEE 802.11 standards, used primarily in Europe), and other technologies having relative short radio propagation range. Thus, the terms “WLAN” and “Wi-Fi” may be sued interchangeably herein.

In addition, although described below in terms of an infrastructure WLAN system including one or more APs and a number of STAs, the example embodiments are equally applicable to other WLAN systems including, for example, multiple WLANs, peer-to-peer systems (e.g., operating according to Wi-Fi Direct protocols), Independent Basic Service Set (IBSS) systems, Wi-Fi Direct systems, and/or Hotspots. Further, although described herein in terms of exchanging data frames between wireless devices, the example embodiments may be applied to the exchange of any data unit, packet, and/or frame between wireless devices. Thus, the term “packet” may include any frame, packet, or data unit such as, for example, protocol data units (PDUs), MAC service data units (MSDUs), MAC protocol data units (MPDUs), and physical layer convergence procedure protocol data units (PPDUs). The term “A-MPDU” may refer to aggregated MPDUs.

In the following description, numerous specific details are set forth such as examples of specific components, circuits, and processes to provide a thorough understanding of the present disclosure. The term “coupled” as used herein means connected directly to or connected through one or more intervening components or circuits. The term “operating frequency” as used herein refers to a maximum clock speed at which a corresponding hardware resource may operate. For example, the operating frequency may affect the rate at which a particular hardware component (e.g., processor, memory controller, transceiver, etc.) is able to process, transmit, receive, and/or store data. The operating frequency may also affect the rate at which a bus is able to communicate data from one hardware component to another. Thus, the terms “operating frequency” and “bandwidth” may be used interchangeably herein.

Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the example wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

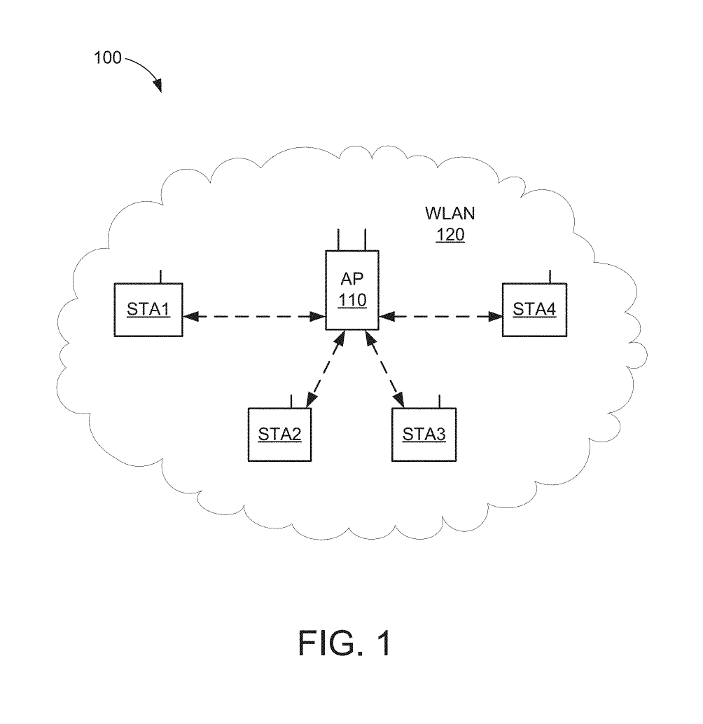

FIG. 1 shows an example wireless network system 100 within which the example embodiments may be implemented. The wireless system 100 is shown to include four wireless stations STA1-STA4, a wireless access point (AP) 110, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that WLAN 120 may be formed by any number of access points such as AP 110. The AP 110 is assigned a unique media access control (MAC) address that is programmed therein by, for example, the manufacturer of the access point. Similarly, each of the stations STA1-STA4 is also assigned a unique MAC address.

The AP 110 may be any suitable device that allows one or more wireless devices to connect to a network (e.g., a local area network (LAN), wide area network (WAN), metropolitan area network (MAN), and/or the Internet) via AP 110 using Wi-Fi, Bluetooth, or any other suitable wireless communication standards. The AP 110 may also be any suitable wireless device (e.g., such as a wireless station) acting as a software-enabled access point (“SoftAP”). For at least one embodiment, AP 110 may include one or more transceivers, one or more processing resources (e.g., processors and/or ASICs), one or more memory resources, and a power source. The memory resources may include a non-transitory computer-readable medium (e.g., one or more nonvolatile memory elements, such as EPROM, EEPROM, Flash memory, a hard drive, etc.) that stores instructions for communicating with the stations STA1-STA4 and/or maintaining the WLAN 120.

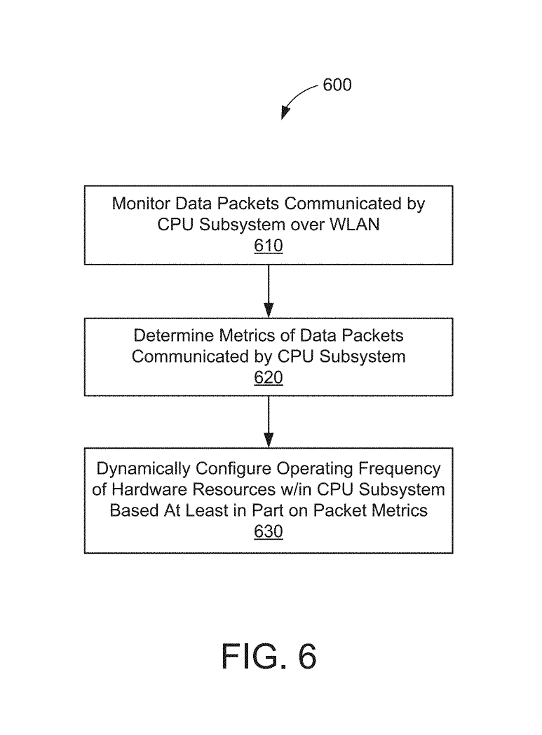

Each of the stations STA1-STA4 may be any suitable Wi-Fi enabled wireless device including, for example, a cell phone, personal digital assistant (PDA), tablet device, laptop computer, or the like. Each station may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, each station may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 6-8.

For the AP 110 and/or stations STA1-STA4, the one or more transceivers may include Wi-Fi transceivers, Bluetooth transceivers, NFC transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate with a 2.4 GHz frequency band and/or within a 5 GHz frequency band in accordance with the IEEE 802.11 standards. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communication protocol). In other embodiments, the transceivers may be any technically feasible transceiver such as a ZigBee transceiver described by the ZigBee specification, WiGig transceiver, and/or a HomePlug transceiver described in one or more standards provided by the HomePlug Alliance.

In example embodiments, each of the stations STA1-STA4 may dynamically adjust an operating frequency and/or bandwidth of its hardware resources based at least in part on the data traffic communicated (by that STA) in the WLAN 120. For example, when a STA experiences a decrease in the rate and/or throughput of incoming or outgoing data, the STA may lower the operating frequency and/or bandwidth of one or more hardware resources (e.g., processors, transceivers, memory controllers, buses, etc.) that are involved in processing and/or signaling the data within the STA. In some embodiments, the STA may adjust the operating frequency and/or bandwidth of the hardware resources using dynamic clock and voltage scaling (DCVS) techniques in response to (Wi-Fi) packet-based triggers. Accordingly, the packet-based DCVS techniques described herein may enable the stations STA1-STA4 to achieve greater power savings even while operating in the active state.

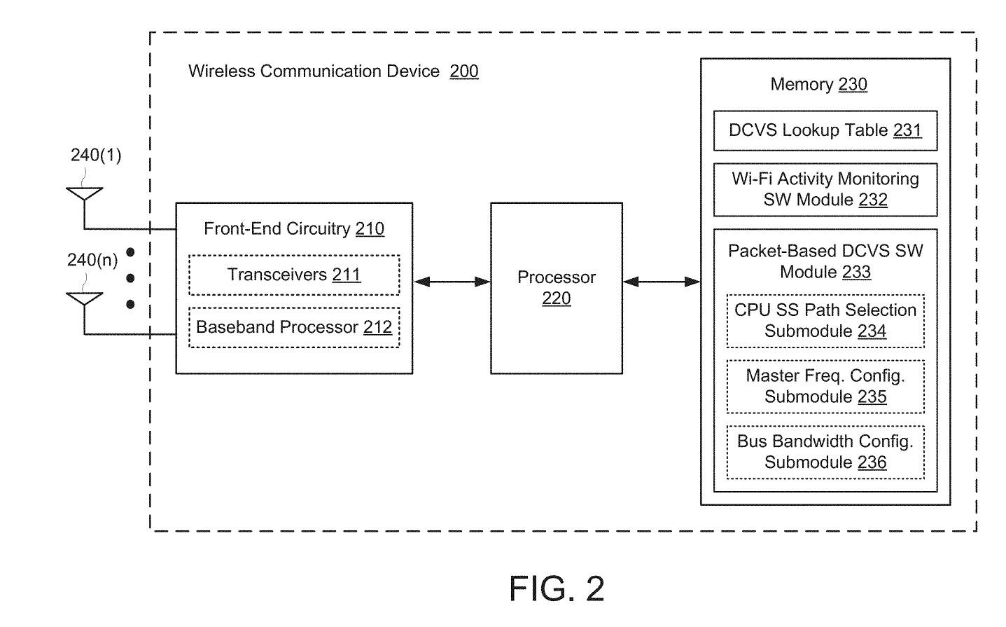

FIG. 2 is a block diagram of a wireless communication device 200 in accordance with example embodiments. The wireless communication device 200 may be an embodiment of at least one of the stations STA1-STA4 or the AP 110 of FIG. 1. Thus, the wireless communication device 200 may include front-end circuitry 210 coupled to a number of antennas 240(1)-240(n), a processor 220, and a memory 230. For purposes of discussion herein, processor 220 is shown in FIG. 2 as being coupled between the front-end circuitry 210 and memory 230. For actual embodiments, the front-end circuitry 210, processor 220, and/or memory 230 may be connected together using one or more buses (not shown for simplicity). Furthermore, the wireless communication device 200 may include a memory controller (not shown for simplicity) that interfaces the memory 230 with the processor 220 and/or front-end circuitry 210.

The front-end circuitry 210 may include one or more transceivers 211 and a baseband processor 212. The transceivers 211 may be coupled to the antennas 240(1)-240(n), either directly or through an antenna selection circuit (not shown for simplicity). The transceivers 211 may be used to communicate wirelessly with one or more STAs, APs, and/or other suitable wireless devices. The baseband processor 212 may be used to process signals received from processor 220 and/or memory 230 and to forward the processed signals to transceivers 211 for transmission via one or more of the antennas 240(1)-240(n). The baseband processor 212 may also be used to process signals received from one or more of the antennas 240(1)-240(n) via transceivers 211 and to forward the processed signals to processor 220 and/or memory 230.

Memory 230 may include a DCVS lookup table 231 that stores a number of predetermined frequency and/or bandwidth configurations for one or more hardware resources of the wireless communication device 200 based on one or more metrics of incoming and/or outgoing data packets. The hardware resources may include the front-end circuitry 210, the processor 220, and/or one or more buses connecting the front-end circuitry 210, the processor 220, and the memory 230. The metrics may include a packet rate, payload size, and/or aggregation factor of the incoming or outgoing data packets. As described in greater detail below, different combinations of the packet metrics may be correlated with different operating frequencies and/or bandwidths for the hardware resources.

Memory 230 may also include a non-transitory computer-readable medium (e.g., one or more nonvolatile memory elements, such as EPROM, EEPROM, Flash memory, a hard drive, and so on) that may store at least the following software (SW) modules:
a Wi-Fi activity monitoring SW module 232 to determine one or more metrics of Wi-Fi data packets transmitted and/or received by the wireless communication device 200 (e.g., via front-end circuitry 210); and
a packet-based DCVS SW module 233 to dynamically configure an operating frequency of one or more hardware resources within the wireless communication device 200 based at least in part on the one or more packet metrics, the packet-based DCVS SW module including:
   a CPU subsystem (SS) path selection submodule 234 to select a signaling path, within the wireless communication device 200, affected by the one or more packet metrics;
   a master frequency configuration submodule 235 to configure and/or adjust an operating frequency of one or more “master” devices (e.g., processors, transceivers, memory controllers, etc.) provided along the selected path; and
   a bus bandwidth configuration submodule 236 to configure and/or adjust a bandwidth of one or more buses connecting the one or more master devices along the selected path.
      Each software module includes instructions that, when executed by processor 220, cause the wireless communication device 200 to perform the corresponding functions. The non-transitory computer-readable medium of memory 230 thus includes instructions for performing all or a portion of the operations described below with respect to FIGS. 6-8.

Processor 220 may be any suitable one or more processors capable of executing scripts or instructions of one or more software programs stored in the wireless communication device 200 (e.g., within memory 230). For example, processor 220 may execute the Wi-Fi activity monitoring SW module 232 to determine one or more metrics of Wi-Fi data packets transmitted and/or received by the wireless communication device 200 (e.g., via front-end circuitry 210). Processor 220 may also execute the packet-based DCVS SW module 233 to dynamically configure an operating frequency of one or more hardware resources within the wireless communication device 200 based at least in part on the one or more packet metrics. In executing the packet-based DCVS SW module 233, the processor 220 may further execute the CPU SS path selection submodule 234, the master frequency configuration submodule 235, and the bus bandwidth configuration submodule 236.

For example, the processor 220 may execute the CPU SS path selection submodule 234 to select a signaling path, within the wireless communication device 200, affected by the one or more packet metrics. Further, the processor 220 may execute the master frequency configuration submodule 235 to configure and/or adjust an operating frequency of one or more master devices (e.g., processors, transceivers, memory controllers, etc.) provided along the selected path. Still further, the processor 220 may execute the bus bandwidth configuration submodule 236 to configure and/or adjust a bandwidth of one or more buses connecting the one or more master devices along the selected path.

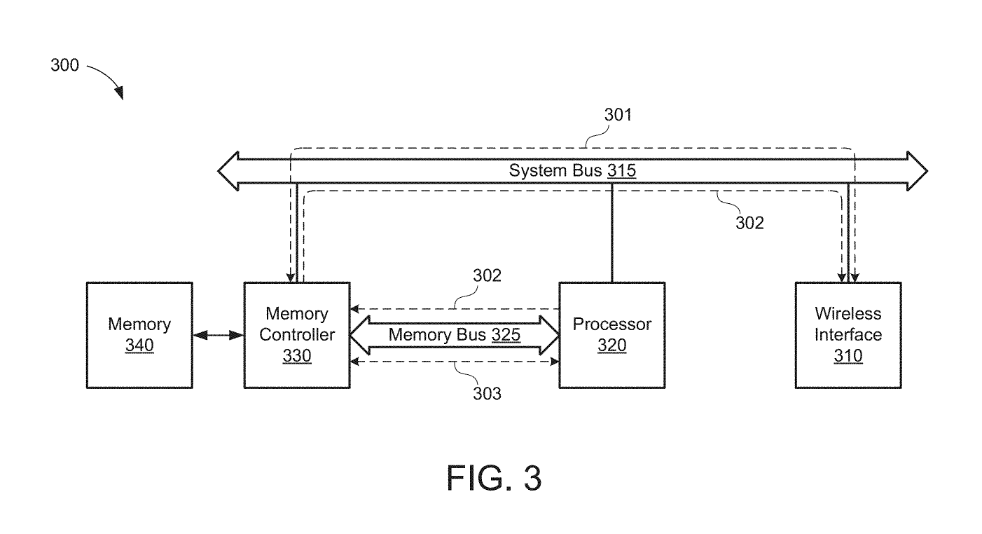

FIG. 3 is a block diagram of a central processing unit (CPU) subsystem 300 of a wireless communication device, in accordance with example embodiments. The CPU subsystem 300 may be used for transmitting and/or receiving Wi-Fi data packets in a wireless communication device (e.g., wireless communication device 200). The CPU subsystem 300 includes a wireless interface 310, a processor 320, a memory controller 330, and memory 340. Each of the wireless interface 310, processor 320, and memory 340 may be an embodiment of the front-end circuitry 210, processor 220, and memory 230, respectively, of FIG. 2.

In the example of FIG. 3, the wireless interface 310, processor 320, and memory controller 330 are each coupled to a shared system bus 315. Further, the processor 320 may be separately coupled to the memory controller 330 via a memory bus 325. As used herein, the term “hardware resource” may refer to any hardware component and/or element of the CPU subsystem 300 including, for example, the wireless interface 310, processor 320, memory controller 330, memory 340, and buses 315 and 325. The term “master” device may refer only to the hardware resources that process, transmit, and/or receive data signaled over the buses (e.g., not including buses 315 or 325, memory controller 330, or memory 340).

Communications within the CPU subsystem 300 may flow along one or more signal paths 301-303. For example, the first signal path 301 may comprise wireless interface 310, system bus 315, and memory controller 330/memory 340. The second signal path 302 may comprise processor 320, memory bus 325, memory controller 330, system bus 315, and wireless interface 310. The third signal path 303 may comprise processor 320, memory bus 325, and memory controller 330/memory 340. The memory controller 330 may interface the processor 320 and/or wireless interface 310 with the memory 340. In example embodiments, any memory access operations may be performed by the memory controller 330. For example, the memory controller 330 may write incoming data to memory 340 (e.g., when receiving wireless data packets) and may read outgoing data from memory 340 (e.g., when transmitting wireless data packets).

The wireless interface 310 may transmit and/or receive wireless data packets over a wireless channel. A wireless packet may include a payload (e.g., the “useful” data) and a packet header (e.g., control information that describes the packet format and/or data in the payload). Upon receiving an incoming data packet, the wireless interface 310 may offload the data packet, via the first signal path 301, to be buffered or stored in memory 340. The wireless interface 310 may further send descriptors (e.g., indicating the location of the incoming payload and/or header data stored in memory 340) to memory 340 via the first signal path 301, and signal an interrupt to the processor 320 indicating the same. The processor 320 may then retrieve the descriptors, via the third signal path 303, to access and/or process the data packet stored in memory 340. For example, the processor 320 may retrieve the payload and/or header data from memory 340 via the third signal path 303.

When transmitting an outgoing data packet, the processor 320 may first buffer and/or store the data packet in memory 340 via the third signal path 303. The processor 320 may then send descriptors (e.g., indicating the location of the outgoing payload and/or header data stored in memory 340) to the wireless interface 310 via the second signal path 302. The wireless interface 310 may use the descriptors to access and/or transmit the data packet stored in memory 340. For example, the wireless interface 310 may retrieve the payload and/or header data from memory 340 via the first signal path 301. The wireless interface 310 may then transmit the data packet over a wireless channel to other devices in a wireless network (not shown for simplicity).

The example embodiments recognize that certain metrics or properties of the data packets may have a direct impact on the hardware resources involved in transmitting and/or receiving the data packets. For example, the overall throughput or size of a data packet may affect the load along the first signal path 301. Specifically, larger packet sizes may cause greater stress on the hardware resources of the first signal path 301, whereas smaller packet sizes may cause less stress on the hardware resources first signal path 301. Further, the number of descriptors associated with a data packet may affect the load along the first signal path 301 and/or third signal path 303. Specifically, having more descriptors may cause greater stress on the hardware resources of the first signal path 301 and/or third signal path 303, whereas having fewer descriptors may cause less stress on the hardware resources of the first signal path 301 and/or third signal path 303.

In example embodiments, the CPU subsystem 300 (e.g., by way of the processor 320 or a separate DCVS controller, not shown for simplicity) may dynamically configure or adjust the operating frequency and/or bandwidth of its hardware resources based at least in part on one or more metrics of incoming and/or outgoing data packets. Specifically, the CPU subsystem 300 may monitor incoming and/or outgoing data packets over a DCVS interval (e.g., ˜100 ms) to determine average packet metrics over the DCVS interval. The CPU subsystem 300 may then determine, given its current DCVS configuration, when to adjust the operating frequency and/or bandwidth of one or more hardware resources based on the average packet metrics.

For some embodiments, the CPU subsystem 300 may reduce the operating frequency and/or bandwidth of one or more hardware resources provided along the first signal path 301 (e.g., including wireless interface 310, memory controller 330, and/or system bus 315) if the average packet size drops below a first threshold size. Similarly, the CPU subsystem 300 may increase the operating frequency and/or bandwidth of one or more hardware resources provided along the first signal path 301 if the average packet size increases beyond a second threshold size. The average packet size may directly correlate with the payload size of incoming and/or outgoing data packets during the DCVS interval (e.g., since the payload typically accounts for the majority of each data packet). In at least one embodiment, the CPU subsystem 300 may dynamically adjust the operating frequency and/or bandwidth of one or more hardware resources provided along the first signal path 301 based at least in part on the payload size of incoming and/or outgoing data packets.

For other embodiments, the CPU subsystem 300 may reduce the operating frequency and/or bandwidth of one or more hardware resources provided along the first signal path 301 and/or the third signal path 303 if the average number of descriptors drops below a first threshold amount. Similarly, the CPU subsystem 300 may increase the operating frequency and/or bandwidth of one or more hardware resources provided along the first signal path 301 and/or the third signal path 303 if the average number of descriptors increases beyond a second threshold amount. The descriptors are typically used to differentiate between different data packets, and/or delineate different portions (e.g., header and payload) of each data packet, stored in memory 340. Thus, the average number of descriptors may directly correlate with the rate of incoming and/or outgoing data packets during the DCVS interval. In at least one embodiment, the CPU subsystem 300 may dynamically adjust the operating frequency and/or bandwidth of one or more hardware resources provided along the first signal path 301 and/or third signal path 303 based at least in part on the rate of incoming and/or outgoing data packets.

As described above, the descriptors may be used to delineate the header from the payload of each data packet stored in memory 340. Packet aggregation is a technique whereby multiple data packets (specifically, their respective payloads) may be “aggregated” together under the same header (e.g., assuming the data packets share the same header information) for a single transmission. For example, multiple MSDUs may be aggregated within a single MPDU. Furthermore, multiple MPDUs may be aggregated within a single PPDU. Thus, the average number of descriptors needed to delineate header information from payload data over a DCVS interval may further depend on a packet aggregation factor (e.g., corresponding to the number of packets aggregated into a single transmission).

Packet aggregation effectively reduces the amount of overhead needed to transmit the same amount of useful data that could otherwise be transmitted without aggregation. Thus, for a given packet rate, a higher aggregation factor (e.g., more data packets are aggregated into a single transmission) may result in fewer descriptors than a lower aggregation factor (e.g., fewer data packets are aggregated into a single transmission). In at least one embodiment, the CPU subsystem 300 may dynamically adjust the operating frequency and/or bandwidth of one or more hardware resources provided along the first signal path 301 and/or third signal path 303 based at least in part on the aggregation factor of incoming and/or outgoing data packets.

The CPU subsystem 300 may adjust the operating frequency of one or more master devices by adjusting their respective clock speeds. For example, the CPU subsystem 300 may reduce the operating frequency of the processor 320 by reducing the speed or frequency of a corresponding processor clock. Reducing the clock speed reduces the maximum rate at which the processor 320 is able to get work done (e.g., process information, execute instructions, read data from memory, write data from memory, etc.). However, this may also reduce the voltage requirements of the processor 320, and thus enables the processor 320 to consume less power to do the same amount of work over a given interval. The CPU subsystem 300 may adjust the operating frequencies of the wireless interface 310 and memory controller 330 in a substantially similar manner (e.g., by reducing their respective clock speeds).

The CPU subsystem 300 may also adjust the bandwidths of one or more buses by adjusting their respective clock speeds. For example, the CPU subsystem 300 may reduce the operating frequency of the system bus 315 by reducing the speed or frequency of a corresponding system bus clock. Reducing the clock speed reduces the maximum rate at which the system bus 315 is able to communicate data from one master device to another. However, this may also reduce the voltage requirements of the system bus 315, and thus enable the system bus 315 to consume less power to communicate the same amount of data over a given interval. The CPU subsystem 300 may adjust the bandwidth of the memory bus 325 in a substantially similar manner.

Some of the hardware resources in the CPU subsystem 300 may belong to multiple signal paths 301-303. For example, the wireless interface 310 is involved in signal paths 301 and 302, processor 302 is involved in signal paths 302 and 303, memory controller 330 is involved in signal paths 301 and 303, and system bus 315 is involved in signal paths 301 and 302. Thus, at least one hardware resource may be affected by changes in multiple packet metrics. For example, an increase in payload size may proportionally increase the load on the memory controller 330 (e.g., via signal path 301), while at the same time a decrease in packet rate may proportionally decrease the load on the memory controller 330 (e.g., via signal path 303). Any net increase or decrease in the load on the memory controller 330 may depend on both the average payload size and packet rate of incoming and/or outgoing data packets.

For some embodiments, the CPU subsystem 300 may resolve any discrepancies in the operating frequencies and/or bandwidths determined based on the different packet metrics by averaging the operating frequencies and/or bandwidths identified for each hardware resource. In other embodiments, the CPU subsystem 300 may resolve such discrepancies by implementing the highest operating frequency and/or bandwidth identified for each hardware resource (e.g., to support worst-case traffic conditions). Still further, for some embodiments, the CPU subsystem 300 may store a number of predetermined frequency and/or bandwidth configurations, for each of the hardware resources, in a lookup table (e.g., DCVS lookup table 231 of FIG. 2) based on various combinations of the packet metrics.

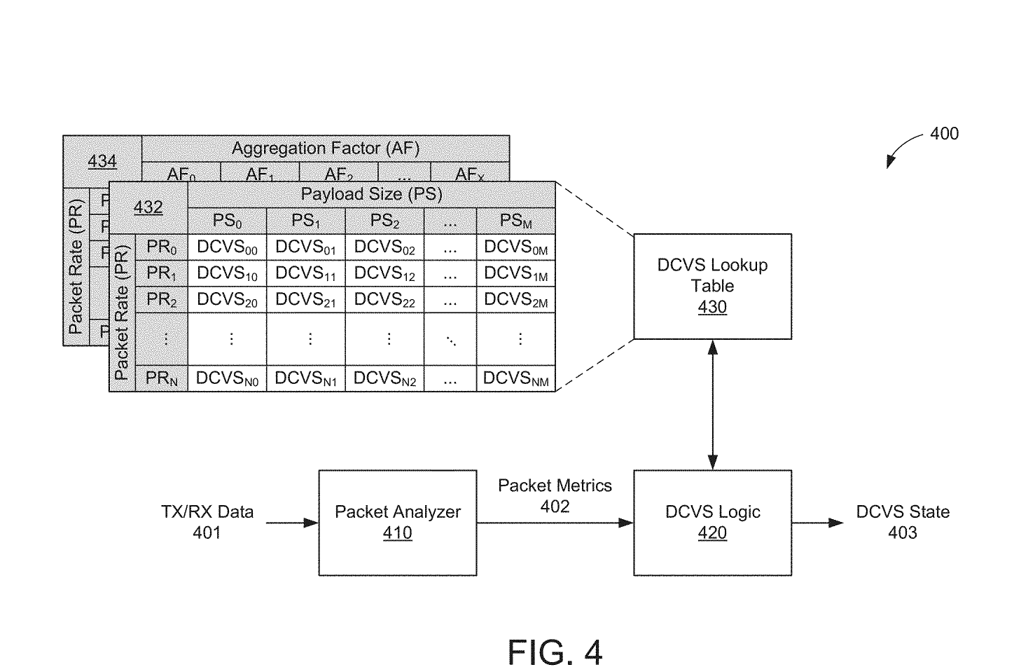

FIG. 4 is a block diagram of a packet-based dynamic clock and voltage scaling (DCVS) controller 400, in accordance with example embodiments. The packet-based DCVS controller 400 may determine a DCVS state 403 of a CPU subsystem (not shown for simplicity) based on outgoing and/or incoming (TX/RX) data 401 communicated by the CPU subsystem. For example, the packet-based DCVS controller 400 may be implemented by the processor 320 of CPU subsystem 300 and/or processor 220 of wireless communication device 200. The packet-based DCVS controller 400 includes a packet analyzer 410, DCVS logic 420, and a DCVS lookup table 430.

The packet analyzer 410 monitors the TX/RX data 401 to determine one or more packet metrics 402. In example embodiments, the packet metrics 402 may include a packet rate (PR), payload size (PS), and/or aggregation factor (AF) of incoming and/or outgoing data packets. In some aspects, the packet analyzer 410 may determine an average packet rate, payload size, and/or aggregation factor of the data packets transmitted and/or received by the CPU subsystem over a given duration (e.g., DCVS interval).

The DCVS logic 420 receives the packet metrics 402 from the packet analyzer 410 and determines a DCVS state 403 based at least in part on the packet metrics 402. The DCVS state 403 may correspond to an operating frequency and/or bandwidth configuration to be implemented for one or more hardware resources of the CPU subsystem. In example embodiments, the DCVS logic 420 may determine the DCVS state 403 by looking up the corresponding packet metrics 402 in a DCVS lookup table 430. For example, the DCVS lookup table 430 may store one or more state configuration tables 432 and 434 indicating the DCVS states (e.g., DCVS₀₀-DCVS_{NM}) associated with various packet metric combinations.

A first state configuration table 432 may indicate DCVS states for various combinations of packet rate relative to payload size. A second state configuration table 434 may indicate DCVS states for various combinations of packet rate relative to aggregation factor. In example embodiments, each packet metric index (e.g., PS₀-PS_{M}, PR₀-PR_{N}, AF₀-AFₓ) may represent a range of values for which the corresponding DCVS state is applicable. For example, one or more of the hardware resources of the CPU subsystem may only be configurable to operate in a number of discrete frequencies and/or bandwidths. Thus, the DCVS logic 420 may not change the current DCVS state 403 unless at least one of the packet metrics 402 rises above an upper threshold of a corresponding packet metric index or drops below a lower threshold of the packet metric index. For example, if the current DCVS state 403 corresponds to DCVS₁₁, the DCVS logic 420 may select a new DCVS state 403 if the packet rate increases above or drops below the PR₁ range and/or the payload size increases above or drops below the PS₁ range.

For some embodiments, the DCVS logic 420 may implement a transition to a higher DCVS state (e.g., corresponding to a higher operating frequency and/or bandwidth for one or more hardware resources) at a different rate than transitioning to a lower DCVS state (e.g., corresponding to lower operating frequency and/or bandwidth for one or more hardware resources). For example, when the packet metrics 402 indicate an increased load on one or more hardware resources, it may be desirable to quickly ramp up the operating frequency and/or bandwidth of the hardware resources to prevent loss of data. On the other hand, when the packet metrics 402 indicate a decreased load on one or more hardware resources, it may be desirable to reduce the operating frequency and/or bandwidth of the hardware resources more gradually (e.g., to ensure that communications will not be negatively impacted by the transition). In example embodiments, the rate at which the DCVS logic 420 transitions to higher DCVS states (e.g., ˜100 ms or a single DCVS interval) may be greater than the rate at which the DCVS logic 420 transitions to lower DCVS states (e.g., ˜200 ms or two DCVS intervals).

The packet metrics 402 of incoming data packets may be different than the packet metrics 402 of outgoing data packets. Moreover, the packet metrics 402 for outgoing data may be controllable by the CPU subsystem and/or corresponding wireless device (e.g., the CPU subsystem may select the payload size, packet rate, and/or aggregation factor to be used for outgoing data transmissions), whereas the packet metrics 402 for incoming data typically are not. Thus, for some embodiments, the DCVS logic 420 may select a first DCVS state based on the packet metrics for the incoming data and a second DCVS state based on the packet metrics for the outgoing data.

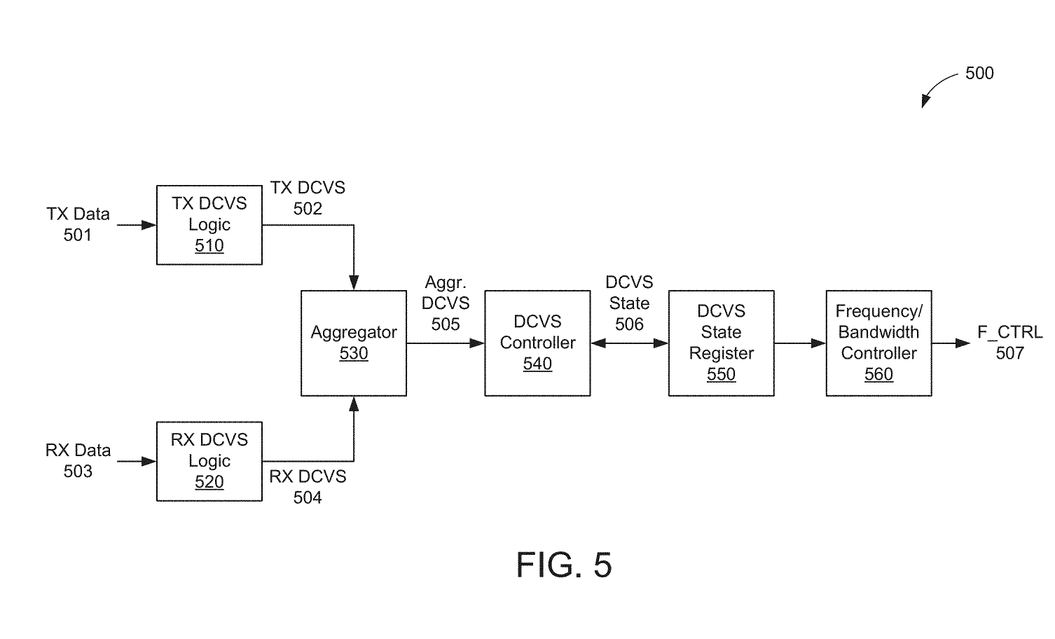

FIG. 5 is a block diagram of a DCVS control system 500 for a wireless communication device, in accordance with example embodiments. The DCVS control system 500 may dynamically configure or adjust an operating frequency and/or bandwidth of one or more hardware resources within a wireless communication device (not shown for simplicity) based on outgoing (TX) data 501 and incoming (RX) data 503. The DCVS control system 500 includes TX DCVS logic 510, RX DCVS logic 520, an aggregator 530, a DCVS controller 540, a DCVS state register 550, and a frequency/bandwidth controller 560.

Each of the TX DCVS logic 510 and RX DCVS logic 520 may be a respective embodiment of the DCVS controller 400 of FIG. 4. For example, the TX DCVS logic 510 may select a first (TX) DCVS state 502 to be implemented by the wireless communication device based on one or more packet metrics of the outgoing data 501. Similarly, the RX DCVS logic 520 may select a second (RX) DCVS state 504 to be implemented by the wireless communication device based on one or more packet metrics of the incoming data 503. For any given DCVS interval, the TX DCVS state 502 selected by the TX DCVS logic 510 may be different than the RX DCVS state 504 selected by the RX DCVS logic 520. However, both the TX DCVS state 502 and the RX DCVS state 504 may affect a common set of hardware resources.

The aggregator 530 may reconcile any differences in operating frequencies and/or bandwidths between the DCVS states 502 and 504. For example, the aggregator 530 may select an aggregate DCVS state 505 that is optimized for the overall flow of wireless data traffic through the wireless communication device. For some embodiments, the aggregator 530 may select the aggregate DCVS state 505 by averaging the operating frequencies and/or bandwidths indicated by the TX DCVS state 502 and the RX DCVS state 504. For other embodiments, the aggregator 530 may select the aggregate DCVS state 505 based on the highest operating frequency and/or bandwidth, for each hardware resource, indicated by either the TX DCVS state 502 or the RX DCVS state 504 (e.g., to support the worst-case traffic conditions represented by either DCVS state).

Typically, the aggregator 530 may update the aggregate DCVS state 505 at regularly scheduled (DCVS) intervals. However, for some embodiments, one or more asynchronous trigger conditions may cause the aggregator to update the aggregate DCVS state 505 sooner or later than normal. For example, as described above with respect to FIG. 4, it may be desirable to transition from a higher DCVS state to a lower DCVS state more slowly (e.g., >DCVS interval) than to transition from a higher DCVS state to a lower DCVS state. Thus, in at least one embodiment, the aggregator 530 may delay implementation (e.g., until after a given DCVS interval) of the TX DCVS state 502 and/or the RX DCVS state 504 if either represents a transition to a lower DCVS state.

For example, if the aggregator 530 detects a new TX DCVS state 502 or RX DCVS state 504 corresponding to a high-to-low state transition, at a given DCVS interval, the aggregator 530 may ignore the new DCVS state when determining the aggregate DCVS state 505 at the given DCVS interval. However, if the same DCVS state (e.g., representing the high-to-low transition) persists during a subsequent DCVS interval, the aggregator 530 may then consider that DCVS state when updating the aggregate DCVS state 505 at the subsequent DCVS interval.

In another embodiment, the aggregator 530 may dynamically adjust the TX DCVS state 502 (e.g., within a DCVS interval) upon detecting a burst condition. Frame (or short interframe space (SIFS)) bursting is a technique that may be used to increase the throughput of communications while reducing the overhead each packet transmission. Specifically, a “burst” of outgoing data packets may be transmitted in rapid succession (e.g., separated by a SIFS duration), without relinquishing control of the wireless medium. To ensure a high throughput of data, frame bursting may require a relatively high DCVS state. However, due to the reduction in overhead, the operating frequency of the clock (and/or related hardware resources) may be relaxed after transmitting the initial frame or packet of the burst.

For example, the TX DCVS logic 510 may detect a frame burst condition while monitoring the TX data 501. Upon detecting the frame burst condition, the TX DCVS logic 510 may select a TX DCVS state 502 that supports the operating frequencies and/or bandwidths required to transmit at least the initial frame or packet of the burst. The TX DCVS logic 510 may then provide the selected TX DCVS state 502, along with information indicating the traffic burst condition, to the aggregator 530. The aggregator 530 may first implement the TX DCVS state 502 selected by the TX DCVS logic 510, and then dynamically reduce the TX DCVS state 502 (e.g., by selecting a lower DCVS state) after a given duration has expired (e.g., after the initial frame or packet of the burst has been transmitted, but before the start of the next DCVS interval).

Still further, in another embodiment, the aggregator 530 may dynamically adjust the TX DCVS state 502 (e.g., within a DCVS interval) based on a duration of inactivity for outgoing data traffic. For example, if the wireless communication device experiences a lull in transmit activity over a given duration, the wireless communication device may generate one or more outgoing data packets for the purpose of maintaining an operating state of the device (e.g., and to prevent memory flushes). The aggregator 530 may recognize these outgoing data packets as “inactivity” packets, and subsequently relax the operating frequency and/or bandwidth requirements that would otherwise be necessitated by a sudden burst in outgoing data traffic.

For example, the TX DCVS logic 510 may activate a TX inactivity timer for each descriptor queued in software (e.g., for the outgoing data 501). Upon expiration of the TX inactivity timer, the TX DCVS logic 510 may signal a TX inactivity condition to the aggregator 530. In response to the TX inactivity condition, the aggregator 530 may dynamically adjust the current TX DCVS state 502 selected by the TX DCVS logic 510. For example, the aggregator 530 may select a new (e.g., lower) DCVS state for the TX DCVS state 502 upon expiration of an inactive threshold (e.g., after the initial inactivity frame or packet has been transmitted, but before the start of the next DCVS interval).

The DCVS controller 540 receives the aggregate DCVS state 505 and selects an overall DCVS state 506 for the wireless communication device. For example, many of the hardware resources involved in transmitting and/or receiving wireless communications may be shared by other processes and/or hardware components. With reference to FIG. 3, the processor 320 of the CPU subsystem 300 may be general purpose processor for a corresponding wireless communication device. Thus, the processor 320 may perform a multitude of tasks, in addition to transmitting and receiving data packets. Furthermore, the system bus 315 may be shared by additional master devices other than those included in the CPU subsystem 300 of FIG. 3. Accordingly, the DCVS controller 540 may implement a “voting” technique to balance the frequency and/or bandwidth requirements for transmitting and receiving data packets (e.g., as indicated by the aggregate DCVS state 505) with other processes that are performed by the wireless communication device.

The DCVS controller 540 may select an overall DCVS state 506 that is optimized for all processes performed by the wireless communication device. For some embodiments, the DCVs controller 540 may select the overall DCVS state 506 by averaging the operating frequencies and/or bandwidths indicated by multiple process-specific DCVS states (e.g., including aggregate DCVS state 505) voted for by each of the hardware and/or software processes executing on the wireless communication device. In other embodiments, the DCVS controller 540 may select the overall DCVS state 506 based on the highest operating frequency and/or bandwidth, for each hardware resource, indicated by any of the process-specific DCVS states (e.g., to support the worst-case traffic conditions represented by any of the DCVS states).

For some embodiments, the DCVS controller 540 may maintain a DCVS floor and/or ceiling. For example, the DCVS floor may represent minimum operating frequencies and/or bandwidths for which the hardware resources may be configured. Similarly, the DCVS ceiling may represent maximum operating frequencies and/or bandwidths for which the hardware resources may be configured. Accordingly, the overall DCVS state 506 selected by the DCVS controller 540 may not include any operating frequency and/or bandwidth below the DCVS floor or above the DCVS ceiling.

The DCVS state register 550 may store the current DCVS state 506 of the wireless communication device. The DCVS controller 540 may periodically update the DCVS state 506 stored by the DCVS state register 550 (e.g., at regular DCVS intervals). Alternatively, the DCVS controller 540 may update the DCVS state 506 in the DCVS state register 550 only when a state transition occurs.

The frequency/bandwidth controller 560 may receive and implement the DCVS state 506 stored in the DCVS state register 550. More specifically, the frequency/bandwidth controller 560 may configure or adjust the operating frequency and/or bandwidth of individual hardware resources as indicated by the DCVS state 506. For example, the frequency/bandwidth controller 560 may generate one or more frequency control (F_CTRL) signals 507 based on the DCVS state 506. The frequency control signals 507 may be sent to the individual hardware resources, and used to control their respective operating frequencies and/or bandwidths.

FIG. 6 is an illustrative flowchart depicting a packet-based DCVS operation 600 in accordance with example embodiments. With reference for example to FIG. 4, the operation 600 may be performed by the packet-based DCVS controller 400 to determine a DCVS state of one or more hardware resources of a CPU subsystem (e.g., of wireless communication device) based on outgoing and/or incoming data packets.

The packet-based DCVS controller 400 monitors data packets communicated by the CPU subsystem over a WLAN (610). For example, with reference to the CPU subsystem 300 of FIG. 3, the DCVS controller 400 may monitor incoming data packets received by the wireless interface 310 and outgoing data packets to be transmitted by the wireless interface 310. For some embodiments, the packet-based DCVS controller 400 may be executed (e.g., as software instructions) by the processor 320.

The packet-based DCVS controller 400 may determine one or more metrics of the data packets communicated by the CPU subsystem (620). For example, the packet analyzer 410 may analyze the incoming and/or outgoing data packets to determine the one or more packet metrics. In example embodiments, the packet metrics may include a packet rate, payload size, and/or aggregation factor of incoming and/or outgoing data packets. In some aspects, the packet analyzer 410 may determine an average packet rate, payload size, and/or aggregation factor of the data packets transmitted and/or received by the CPU subsystem over a given duration (e.g., DCVS interval).

Further, the packet-based DCVS controller 400 may dynamically configure an operating frequency of one or more hardware resources within the CPU subsystem based at least in part on the packet metrics (630). For example, the DCVS logic 420 may determine a DCVS state for the one or more hardware resources based at least in part on the packet metrics. As described above, the DCVS state may correspond to an operating frequency and/or bandwidth configuration to be implemented for the one or more hardware resources. For some embodiments, the DCVS logic 420 may determine the DCVS state by looking up the corresponding packet metrics in a DCVS lookup table 430.

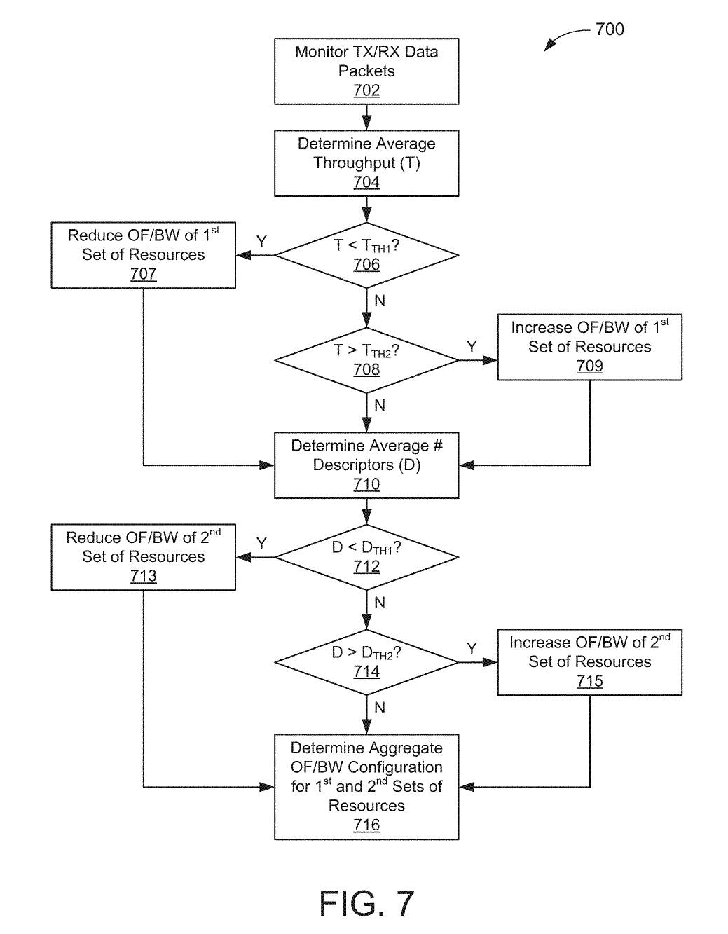

FIG. 7 is an illustrative flowchart depicting a more detailed DCVS operation 700 based on incoming and/or outgoing data packets, in accordance with example embodiments. With reference for example to FIG. 4, the operation 700 may be performed by the packet-based DCVS controller 400 to determine a DCVS state of one or more hardware resources of a CPU subsystem (e.g., of wireless communication device) based on outgoing and/or incoming data packets.

The packet-based DCVS controller 400 monitors incoming and/or outgoing data packets communicated by the CPU subsystem (702). For example, with reference to the CPU subsystem 300 of FIG. 3, the DCVS controller 400 may monitor incoming data packets received by the wireless interface 310 and outgoing data packets to be transmitted by the wireless interface 310. For some embodiments, the packet-based DCVS controller 400 may be executed (e.g., as software instructions) by the processor 320.

The packet-based DCVS controller 400 determines an average throughput of the incoming and/or outgoing data packets (704). For example, the average throughput may be measured over a predetermined DCVS interval. As described above, with reference to FIG. 3, the average throughput may affect the load along the first signal path 301. Specifically, greater throughput may cause greater stress on the hardware resources of the first signal path 301, whereas smaller throughput may cause less stress on the on the hardware resources of the first signal path 301. The average throughput may directly correlate with the payload size of the incoming and/or outgoing data packets (e.g., during the DCVS interval) as well as the MAC service data unit (MSDU) rate.

In example embodiments, the packet-based DCVS controller 400 may dynamically configure or adjust the operating frequency (OF) and/or bandwidth (BW) of a first set of hardware resources of the CPU subsystem based at least in part on the average throughput of the incoming and/or outgoing data packets. In some aspects, the DCVS controller 400 may monitor the average throughput of the incoming and/or outgoing data packets for a threshold duration (e.g., 200 ms) before determining whether to adjust the operating frequency and/or bandwidth of the first set of hardware resources. With reference for example to FIG. 3, the first set of hardware resources may be provided along the first signal path 301 (e.g., including wireless interface 310, memory controller 330, and system bus 315). The packet-based DCVS controller 400 may compare the average throughput (T) with a first throughput threshold (T_{TH1}) and a second throughput threshold (T_{TH2}) to determine how to configure the operating frequency and/or bandwidth of the first set of hardware resources.

The first throughput threshold T_{TH1} may correspond to a lower DCVS state-transition boundary. Thus, if the average throughput is below the first throughput threshold T_{TH1} (as tested at 706), the packet-based DCVS controller 400 may reduce the operating frequency and/or bandwidth of one or more hardware resources in the first set (707). For example, the DCVS logic 420 may select a new DCVS state (e.g., from the DCVS lookup table 430) that provides a lower operating frequency and/or bandwidth for the one or more hardware resources in the first set.

The second throughput threshold T_{TH2} may correspond to an upper DCVS state-transition boundary. Thus, if the average throughput is above the second throughput threshold T_{TH2} (as tested at 708), the packet-based DCVS controller 400 may increase the operating frequency and/or bandwidth of one or more hardware resources in the first set (709). For example, the DCVS logic 420 may select a new DCVS state (e.g., form the DCVS lookup table 430) that provides a higher operating frequency and/or bandwidth for the one or more hardware resources in the first set.

The packet-based DCVS controller 400 further determines an average number of descriptors associated with the incoming and/or outgoing data packets (710). For example, the average number of descriptors may also be measured over a predetermined DCVS interval. As described above, with reference to FIG. 3, the average number of descriptors may affect the load along the first signal path 301 and third signal path 303. Specifically, having more descriptors may cause greater stress on the hardware resources of the first signal path 301 and/or third signal path 303, whereas having fewer descriptors may cause less stress on the hardware resources of the first signal path 301 and/or third signal path 303. The average number of descriptors may directly correlate with the rate of incoming and/or outgoing data packets (e.g., during the DCVS interval) and an aggregation factor of the data packets.

In example embodiments, the packet-based DCVS controller 400 may dynamically configure or adjust the operating frequency and/or bandwidth of a second set of hardware resources of the CPU subsystem based at least in part on the average number of descriptors associated with the incoming and/or outgoing data packets. With reference for example to FIG. 3, the second set of hardware resources may be provided along the second signal path 302 (e.g., including processor 320, memory bus 325, memory controller 330, system bus 315, and wireless interface 310) and/or the third signal path 303 (e.g., including processor 320, memory controller 330, and memory bus 325). The packet-based DCVS controller 400 may compare the average number of descriptors (D) with a first descriptor threshold (D_{TH1}) and a second descriptor threshold (D_{TH2}) to determine how to configure the operating frequency and/or bandwidth of the second set of hardware resources.

The first descriptor threshold D_{TH1} may correspond to a lower DCVS state-transition boundary. Thus, if the average number of descriptors is below the first descriptor threshold D_{TH1} (as tested at 712), the packet-based DCVS controller 400 may reduce the operating frequency and/or bandwidth of one or more hardware resources in the second set (713). For example, the DCVS logic 420 may select a new DCVS state (e.g., from the DCVS lookup table 430) that provides a lower operating frequency and/or bandwidth for the one or more hardware resources in the second set.

The second descriptor threshold D_{TH2} may correspond to an upper DCVS state-transition boundary. Thus, if the average number of descriptors is above the second descriptor threshold D_{TH2} (as tested at 714), the packet-based DCVS controller 400 may increase the operating frequency and/or bandwidth of one or more hardware resources in the second set (715). For example, the DCVS logic 420 may select a new DCVS state (e.g., from the DCVS lookup table 430) that provides a higher operating frequency and/or bandwidth for the one or more hardware resources in the second set.

Finally, the packet-based DCVS controller 400 may determine an aggregate operating frequency and/or bandwidth configuration for the first and second sets of resources (716). As described above, with reference to FIG. 3, some of the hardware resources in the CPU subsystem 300 may belong to multiple signal paths 301-303. Thus, at least one hardware resource may be affected by changes in multiple packet metrics. Any net increase or decrease in the load on a particular hardware resource may depend on both the average throughput and average number of descriptors associated with the incoming and/or outgoing data packets communicated over a DCVS interval.

For some embodiments, the packet-based DCVS controller 400 may resolve any discrepancies in the operating frequencies and/or bandwidths determined based on the different packet metrics by averaging the operating frequencies and/or bandwidths identified for each hardware resource. In other embodiments, the packet-based DCVS controller 400 may resolve such discrepancies by implementing the highest operating frequency and/or bandwidth identified for each hardware resource (e.g., to support worst-case traffic conditions). Still further, for some embodiments, the packet-based DCVS controller 400 may store a number of predetermined frequency and/or bandwidth configurations, for each of the hardware resources, in a lookup table (e.g., DCVS lookup table 430) based on various combinations of the packet metrics.

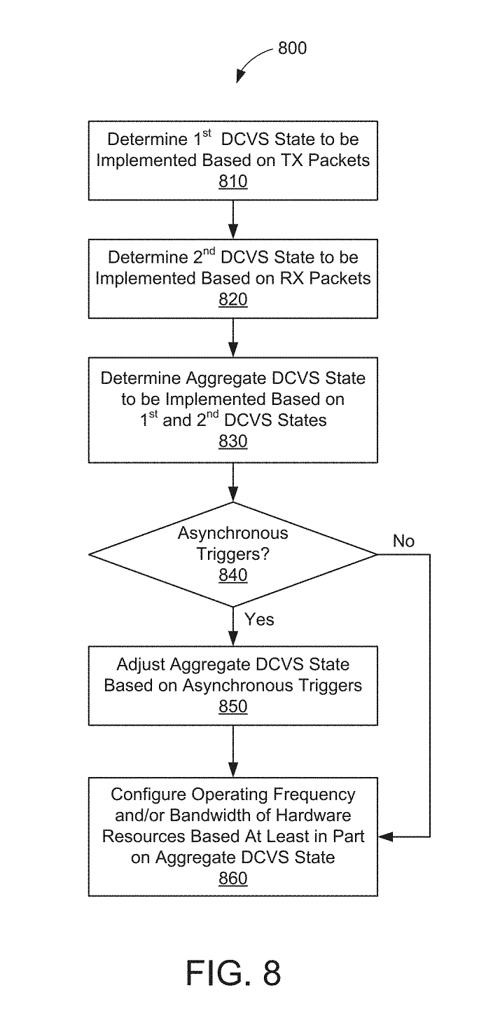

FIG. 8 is an illustrative flowchart depicting a packet-based DCVS operation 800 with asynchronous triggers, in accordance with example embodiments. With reference for example to FIG. 5, the operation 800 may be performed by the DCVS control system 500 to determine a DCVS state of one or more hardware resources of a wireless communication device based on outgoing and/or incoming data packets.

The DCVS control system 500 may determine a first DCVS state to be implemented by the wireless communication device based on outgoing (TX) data packets (810). For example, the TX DCVS logic 510 may select the first DCVS state based on the outgoing data 501. The TX DCVS logic 510 may be an example embodiment of the DCVS controller 400 of FIG. 4. Thus, the TX DCVS logic 510 may determine the first DCVS state based on one or more packet metrics of the outgoing data 501 (e.g., as described above with respect to FIGS. 4 and 7).

The DCVS control system 500 may determine a second DCVS state to be implemented by the wireless communication device based on incoming (RX) data packets (820). For example, the RX DCVS logic 520 may select the second DCVS state based on the incoming data 503. The RX DCVS logic 520 may be an example embodiment of the DCVS controller 400 of FIG. 4. Thus, the RX DCVS logic 520 may determine the second DCVS state based on one or more packet metrics of the incoming data 503 (e.g., as described above with respect to FIGS. 4 and 7).

The DCVS control system 500 may then determine an aggregate DCVS state to be implemented by the wireless communication device based on the first and second DCVS states (830). As described above, with respect to FIG. 5, both the first and second DCVS states may affect a common set of hardware resources. Thus, for some embodiments, the aggregator 530 may reconcile any differences in operating frequencies and/or bandwidths between the first and second DCVS states. For example, the aggregator 530 may select an aggregate DCVS state that is optimized for the overall flow of wireless data traffic through the wireless communication device.

For some embodiments, the aggregator 530 may select the aggregate DCVS state by averaging operating frequencies and/or bandwidths indicated by the first DCVS state and the second DCVS state. For other embodiments, the aggregator 530 may select the aggregate DCVS state based on the highest operating frequency and/or bandwidth, for each hardware resource, indicated by either the first DCVS state or the second DCVS state (e.g., to support the worst-case traffic conditions represented by either of the DCVS states).

Further, for some embodiments, the DCVS control system 500 may dynamically adjust the aggregate DCVS state based on one or more asynchronous triggers. As described above, with respect to FIG. 5, an asynchronous trigger condition may cause the DCVS control system 500 (specifically, the aggregator 530) to update the aggregate DCVS state sooner or later than scheduled. Asynchronous trigger conditions may include a state transition from a higher DCVS state to a lower DCVS state, a frame bursting condition, or a duration of inactivity for outgoing data traffic. If an asynchronous trigger condition is detected (as tested at 840), the DCVS control system 500 may adjust the aggregate DCVS state based at least in part on the asynchronous triggers (850).

For example, the DCVS control system 500 may delay implementation (e.g., until after a given DCVS interval) of the first DCVS state and/or the second DCVS state if either represents a transition to a lower DCVS state. If a frame bursting condition is detected, the DCVS control system 500 may implement the first DCVS state and then dynamically reduce the first DCVS state (e.g., by selecting a lower DCVS state) after a given duration has expired (e.g., after the initial frame or packet of the burst has been transmitted, but before the start of the next DCVS interval). Similarly, if a duration of inactivity is detected, the DCVS control system 500 may dynamically reduce the first DCVS state (e.g., by selecting a lower DCVS state) upon expiration of an inactive threshold (e.g., after an initial inactivity frame or packet has been transmitted, but before the start of the next DCVS interval).

Finally, the DCVS control system 500 may configure an operating frequency and/or bandwidth of one or more hardware resources of the wireless communication device based at least in part on the aggregate DCVS state (860). As described above, many of the hardware resources involved in transmitting and/or receiving wireless communications may be shared by other processes and/or hardware components. Thus, the DCVS controller 540 may select an overall DCVS state that is optimized for all processes performed by the wireless communication device. For example, the DCVS controller 540 may implement a voting technique to balance the frequency and/or bandwidth requirements for transmitting and receiving data packets (e.g., as indicated by the aggregate DCVS state) with other processes that are performed by the wireless communication device. For some embodiments, the DCVS controller 540 may maintain a DCVS floor and/or ceiling when determining the overall DCVS state.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method for dynamic clock and voltage scaling (DCVS) in a central processing unit (CPU) subsystem of a wireless communication device, the method comprising:
monitoring data packets communicated by the CPU subsystem over a wireless local area network (WLAN);
determining one or more metrics of the data packets communicated by the CPU subsystem; and
dynamically configuring an operating frequency of one or more hardware resources of the CPU subsystem based at least in part on the one or more metrics.

2. The method of claim 1, wherein the one or more metrics includes at least one of a packet rate, a payload size, an aggregation factor, a packet size, or a number of descriptors associated with the data packets.

3. The method of claim 2, wherein the dynamically configuring comprises:
reducing the operating frequency of at least one of the hardware resources provided along a first signal path, between a wireless interface and a memory, if at least one of the payload size or the packet rate drops below a corresponding threshold level.

4. The method of claim 3, wherein the hardware resources provided along the first signal path include the wireless interface, a bus coupled between the wireless interface and the memory, and a memory controller that interfaces the wireless interface with the memory.

5. The method of claim 2, wherein the dynamically configuring comprises:
reducing the operating frequency of at least one of the hardware resources provided along a second signal path, between a wireless interface and a processor, if the packet rate drops below a threshold level or the aggregation factor increases beyond a threshold amount.

6. The method of claim 5, wherein the hardware resources provided along the second signal path include the wireless interface, the processor, a memory controller, a first bus coupled between the memory controller and the processor, and a second bus coupled between the memory controller and the wireless interface.

7. The method of claim 2, wherein the dynamically configuring comprises:
reducing the operating frequency of at least one of the hardware resources provided along a third signal path, between a processor and a memory, if the packet rate drops below a threshold level or the aggregation factor increases beyond a threshold amount.

8. The method of claim 7, wherein the hardware resources provided along the third signal path include the processor, a bus coupled between the processor and the memory, and a memory controller that interfaces the processor with the memory.

9. The method of claim 1, wherein the one or more metrics indicates a burst of outgoing data traffic, and wherein the dynamically configuring comprises:
increasing the operating frequency of the one or more hardware resources for a threshold duration at the start of the burst; and
reducing the operating frequency of the one or more hardware resources, for the remainder of the burst, after the threshold duration has elapsed.

10. The method of claim 1, wherein the one or more metrics indicates a duration of inactivity for outgoing data traffic, and wherein the dynamically configuring comprises:
generating an outgoing data packet if the duration of inactivity exceeds an inactive threshold; and
decreasing the operating frequency of the one or more hardware resources if the duration of inactivity exceeds an inactive threshold.

11. The method of claim 1, wherein the dynamically configuring comprises:
selectively increasing the operating frequency of the one or more hardware resources at a first rate; and
selectively decreasing the operating frequency of the one or more hardware resources at a second rate, wherein the first rate is greater than the second rate.

12. A wireless communication device, comprising:
one or more processors; and
a memory storing instructions that, when executed by the one or more processors, cause the wireless communication device to:
monitor data packets communicated by a central processing unit (CPU) subsystem of the wireless communication device over a wireless local area network (WLAN);
determine one or more metrics of the data packets communicated by the CPU subsystem; and
dynamically configure an operating frequency of one or more hardware resources of the CPU subsystem based at least in part on the one or more metrics.

13. The wireless communication device of claim 12, wherein the one or more metrics includes at least one of a packet rate, a payload size, an aggregation factor, a packet size, or a number of descriptors associated with the data packets.

14. The wireless communication device of claim 13, wherein execution of the instructions to dynamically configure the operating frequency of the one or more hardware resources causes the wireless communication device to:
reduce the operating frequency of at least one of the hardware resources provided along a first signal path, between a wireless interface and a memory, if at least one of the payload size or the packet rate drops below a corresponding threshold level, wherein the hardware resources provided along the first signal path include the wireless interface, a bus coupled between the wireless interface and the memory, and a memory controller that interfaces the wireless interface with the memory.

15. The wireless communication device of claim 13, wherein execution of the instructions to dynamically configure the operating frequency of the one or more hardware resources causes the wireless communication device to:
reduce the operating frequency of at least one of the hardware resources provided along a second signal path, between a wireless interface and a processor, if the packet rate drops below a threshold level or the aggregation factor increases beyond a threshold amount, wherein the hardware resources provided along the second signal path include the wireless interface, the processor, a memory controller, a first bus coupled between the memory controller and the processor, and a second bus coupled between the memory controller and the wireless interface.

16. The wireless communication device of claim 13, wherein execution of the instructions to dynamically configure the operating frequency of the one or more hardware resources causes the wireless communication device to:
reduce the operating frequency of at least one of the hardware resources provided along a third signal path, between a processor and a memory, if the packet rate drops below a threshold level or the aggregation factor increases beyond a threshold amount, wherein the hardware resources provided along the third signal path include the processor, a bus coupled between the processor and the memory, and a memory controller that interfaces the processor with the memory.

17. The wireless communication device of claim 12, wherein the one or more metrics indicates a burst of outgoing data traffic, and wherein execution of the instructions to dynamically configure the operating frequency of the one or more hardware resources causes the wireless communication device to:
increase the operating frequency of the one or more hardware resources for a threshold duration at the start of the burst; and
reduce the operating frequency of the one or more hardware resources, for the remainder of the burst, after the threshold duration has elapsed.

18. The wireless communication device of claim 12, wherein the one or more metrics indicates a duration of inactivity for outgoing data traffic, and wherein execution of the instructions to dynamically configure the operating frequency of the one or more hardware resources causes the wireless communication device to:
generate an outgoing data packet if the duration of inactivity exceeds an inactive threshold; and
decrease the operating frequency of the one or more hardware resources if the duration of inactivity exceeds an inactive threshold.

19. The wireless communication device of claim 12, wherein execution of the instructions to dynamically configure the operating frequency of the one or more hardware resources causes the wireless communication device to:
selectively increase the operating frequency of the one or more hardware resources at a first rate; and
selectively decrease the operating frequency of the one or more hardware resources at a second rate, wherein the first rate is greater than the second rate.

20. A non-transitory computer-readable medium storing instructions that, when executed by one or more processors of a wireless communication device, cause the wireless communication device to perform operations comprising:
monitoring data packets communicated by a central processing unit (CPU) subsystem of the wireless communication device over a wireless local area network (WLAN);
determining one or more metrics of the data packets communicated by the CPU subsystem; and
dynamically configuring an operating frequency of one or more hardware resources of the CPU subsystem based at least in part on the one or more metrics.
